(19) United States
(12) Patent Application Publication
(10) Pub. No.: US 2006/0235549 A1
(43) Pub. Date: Oct. 19, 2006

(54) Method for operating a medical device

(76) Inventors: Andrea Hearn, Neunkirchen am Brand (DE); Manfred Wischlitzki, Rottenbach (DE)

Correspondence Address: BRINKS HOFER GILSON & LIONE, P.O. BOX 10395, CHICAGO, IL, 60610, US

(21) Appl. No.: 11/359,310

(22) Filed: Feb. 21, 2006

Related U.S. Application Data
(60) Provisional application No. 60/655,817, filed on Feb. 24, 2005.

(51) Int. Cl. G06F 17/00; G01N 23/06

(52) U.S. Cl. 700/90; 378/51

(57) ABSTRACT

A medical device is located in an examination and/or treatment room, while a central maintenance unit, connected to the medical device via a remote connection, is located outside the examination and/or treatment room. A startup phase of the medical device is initiated either from the central maintenance unit before the beginning of an on-site attendance period or from the examination and/or treatment room after the beginning of the on-site attendance period, including the establishment of data communication with the central maintenance

[symbol]

### RELATED APPLICATIONS

This application claims the benefit of U.S. Provisional Application Ser. No. 60/655,817, filed on Feb. 24, 2005, which is incorporated herein by reference.

### TECHNICAL FIELD

The application relates to a method for operating a medical device, such as a motor-adjustable X-ray unit.

### BACKGROUND

Typically, such medical devices as CT scanners, angiography systems, or MRI units are not ready for operation until after a startup phase, lasting about 30 minutes, for instance. This startup, also called the initializing process, thus significantly limits the availability of the medical device. Further limitations to the availability of the medical device can occur if the medical device has to be re-started during the intended period of operation.

### SUMMARY

The availability of the medical device installed in a hospital or in a medical practice may be increased. A medical device, for instance a radiological diagnostic system or MRI unit, may be located in an examination and/or treatment room, while a central maintenance unit is located outside the examination and/or treatment room. Between the central maintenance unit and the medical device, there is a remote connection, or such a connection can be established, such that data may be read out of the medical device, and to permit control of the medical device from a central maintenance unit.

A startup phase of the medical device can be initiated either from the central maintenance unit or on site: that is, from either of the examination or treatment room. In an aspect, the startup phase of the medical device begins prior to the beginning of an on-site attendance period; that is, before a time by which technicians who attend to the medical device are on site. The entire startup phase may be concluded before the on-site attendance period begins. Thus, the medical device is ready for operation during the entire on-site attendance period. In another aspect, there may be a so-called “warm start” of the medical device; that is, a startup during the usual operation time, especially after the beginning of the on-site attendance period. The technicians who may operate the device and are present on site can initiate the startup phase of the medical device from the examination and/or treatment room. In each of the aspects described above, corresponding data making it possible to observe this process and, optionally, influence it from outside the examination and/or treatment room are automatically transmitted to the central maintenance unit via the remote connection. In a further aspect, a servicing technician, present in the central maintenance unit, may be given an indication that the user of the medical device is starting the startup phase. Alternatively, the beginning of the startup phase, and data related thereto, can also be documented on a data storage medium.

The startup phase of the medical device may be linked with a functional test, or may form an integral procedure with a functional test. The functional test may include a check of essential system parameters of the medical device, and automatic transmission of data to the central maintenance unit. If, during the startup phase, data from the medical device are obtained which are outside specified parameter ranges, a corresponding automatic notice is given on site and/or in the central maintenance unit. The parameter ranges may be adjustable. In this way, fast intervention into the process of starting up the medical device is possible. A high degree of automation is attainable by providing that the course of the startup phase depends on settings and functions of the medical device that are detected during the startup phase. For instance, if a malfunction of the medical device is found, a further test, which otherwise would not have to be performed, can be started automatically.

During the startup phase, a so-called “vicinity check” is automatically performed, which pertains to other devices, such as an air conditioner, in the examination and/or treatment room. As examples, in the course of the vicinity check, the temperature in the examination and/or treatment room or a temperature of a component of a device, including the medical device, installed in the examination and/or treatment room can be measured. In this aspect, temperature-sensitive components, such as semiconductor X-ray detectors in particular, can be checked. Such detectors, are often kept permanently at operating temperature. However, adjusting the operating temperature of the X-ray detector can be performed automatically during the startup phase, without introducing additional time delays.

Another temperature-critical component of a medical device is a superconducting magnet, which must be cooled to very low temperatures, in an MRI system. In this situation as well, the system check performed during the course of the startup phase of the medical device may include temperature monitoring of the superconducting coils.

For data linkage of the medical device with at least one further diagnostic-, therapeutic-, or building-facility device, or other device set up in the examination and/or treatment room, a data transmission module that can be integrated with the medical device may be provided, which may also serve to establish the communication with the central maintenance unit. The data transmission module may be included in the self test during the startup phase of the medical device, and may establish a communication link with a hospital information system, a radiology information system, or some other higher-echelon data processing system.

Thus, a medical device can be started and proactively monitored in a simple, time-saving, manner via a remote connection: that is, a so-called “remote-power-on”, with an integrated comprehensive system test which may also include monitoring of parameters not pertaining solely to the medical device. If deviations occur from predetermined parameters, the servicing technician can immediately decide what further diagnostic steps to take or perform an on-site visit, or the like.

### BRIEF DESCRIPTION OF THE DRAWINGS

FIG. 1, shows a time line of a startup phase of a medical device; and

FIG. 2, is a block diagram showing the linkage of a medical device, set up in a examination and/or treatment room, with an external central maintenance unit.

### DETAILED DESCRIPTION

Exemplary embodiments may be better understood with reference to the drawings, but these examples are not intended to be of a limiting nature.

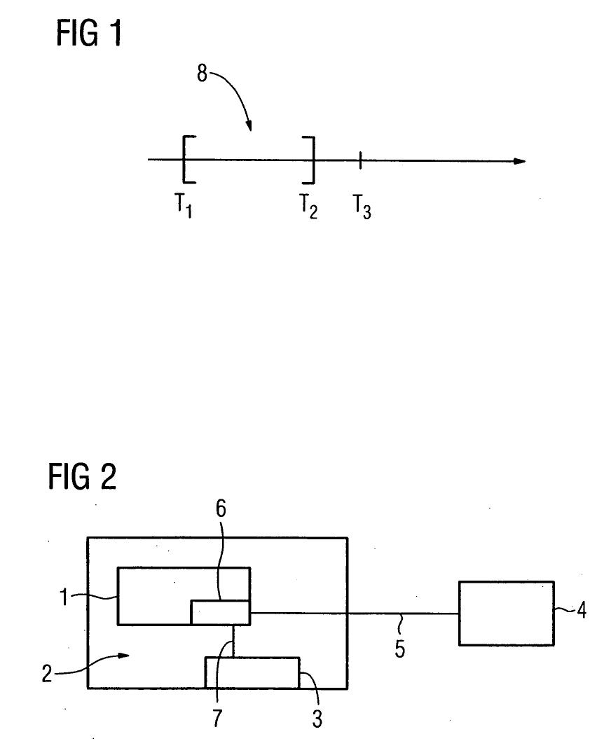

FIGS. 1 and 2 illustrate the operation of a medical device 1, for example a CT scanner or an MRI unit. The medical device 1 may be any diagnostic and/or therapeutic device, or a system which includes a plurality of such devices. The medical device 1 is set up in an examination and/or treatment room 2, in which a further device 3, such as an air conditioner, is also located. Outside the examination and/or treatment room 2 is a central maintenance unit 4, which is connected to the medical device 1 via a remote connection 5, which can either be a wired or wireless connection, and may communicate through a communications network.

For bidirectional communication between the medical device 1 and the central maintenance unit 4, the medical device 1 has a data transmission module 6. This module simultaneously makes a connection with the air conditioner 3 by any wired or wireless means, including a communications network connection. The data transmission module 6 may also have a link (not shown) to a higher-echelon data processing system, such as a hospital information system and/or a radiology information system. For transmitting image data recorded by the medical device 1, a special data transmission protocol for medical image data (DICOM Nodes) may be used.

To achieve operational readiness, the medical device 1 may go through a startup phase that may last about 20 to 30 minutes. The startup phase is represented in FIG. 1 by brackets, and identified overall by reference numeral 8. The beginning of the startup phase is time T₁; at time T₂, the startup phase is concluded. The entire startup phase 8, also called “booting”, may be initiated from the central maintenance unit 4 and monitored from the central maintenance facility 4 as needed and occurs before a time T₃, which represents the beginning of an on-site attendance period. Between time T₁ and time T₃, there may be a period of approximately one hour, for instance. The term “on-site attendance period” means the period of time during which technicians who attend to the medical device 1 are on site, such as inside or in the vicinity of the examination and/or treatment room 2. The on-site attendance period at time T₃ may thus correspond to the work shifts of the persons in the hospital or medical practice who are responsible for operating the medical device 1. Prior to the beginning of startup or initializing process at time T₁, the medical device 1 is typically in a so-called standby or sleep mode in which, depending on the type of medical device 1, individual components, which may require an especially long startup phase, may be kept in operational readiness. The startup phase may occur during periods of attendance inside or in the vicinity of the examination and/or treatment room 2.

If deviations from parameter limits are found during the startup phase 8 in a comprehensive system check, such as the absence of a component of the medical device 1 or a malfunction, then a corresponding report may be automatically transmitted to the central maintenance unit 4. Inside the examination and/or treatment room 2, a report may be issued to the equipment operators by means of an output device (not shown), such as a screen or a printer. Setting the startup phase 8 to occur chronologically before the beginning of the on-site attendance period has an advantage that during the entire on-site attendance period, the medical device 1 is available for examination and/or therapy. Error correction may be done from the central maintenance unit 4 as needed before time T₃. If booting of the medical device 1 is necessary during the usual work shift, that is, after time T₃, for instance, in the form of a warm start following a previous interruption, then a report may be automatically generated and transmitted to the central maintenance unit 4 by means of the data transmission module 6.

During the startup phase 8, not only may the function of the medical device 1 automatically tested, but also the function of the further device 3, in this example the air conditioner, in the examination and/or treatment room 2. An enable signal, which is recognizable to the operator of the medical device and may be also transmitted to the central maintenance unit 4, is not output until the proper function of both the medical device 1 and the further device 3 has been ascertained. In each case, status information may be automatically generated after the termination of the startup phase 8.

Although the present invention has been explained by way of the examples described above, it should be understood to the ordinary skilled person in the art that the invention is not limited to the examples, but rather that various changes or modifications thereof are possible without departing from the spirit of the invention. Accordingly, the scope of the invention shall be determined only by the appended claims and their equivalents.

1. A method for operating a medical device, located in an examination and/or treatment room, the method comprising:
connecting a central maintenance unit located outside the examination and/or treatment room to the medical device via a remote data connection;
initiating a startup phase of the medical device:
(a) from the central maintenance unit before the beginning of an on-site attendance period;
and/or,
(b) from the examination and/or treatment room after the beginning of the on-site attendance period and communicating the results of the test to the central maintenance facility.

2. The method of claim 1, wherein during the startup phase a functional test of the medical device is automatically performed.

3. The method of claim 1, wherein data obtained during the startup phase and pertaining to the medical device are automatically transmitted to the central maintenance unit

4. The method of claim 1, wherein when deviations in data obtained during the startup phase exist with respect to predetermined parameter ranges, a report is automatically generated in the central maintenance unit and/or the examination and/or treatment room.

5. The method of claim 1, wherein the specific course of the startup phase depends on settings and functions of the medical device that are detected during the startup phase.

6. The method of claim 1 wherein, during the startup phase of the medical device, a vicinity check is automatically performed of at least one further device in the examination and/or treatment room

7. The method of claim 6, wherein during the vicinity check, the temperature in the examination and/or treatment room a temperature of a component of at least one of a further device, or a medical device, in the examination and/or treatment room is measured.

8. The method of claim 6, wherein during the vicinity check, a data transmission module connected to or integrated with the medical device is automatically tested.

9. The method of claim 1, wherein
the medical device operates with X-radiation.

10. The method of claim 9, wherein during the startup phase, a semiconductor X-ray detector of the medical device is brought to operating temperature.

11. The method of claim 1 wherein initiating comprises initiating from the central maintenance unit before the beginning of the on-site attendance period;

12. The method of claim 1 wherein initiating comprises initiating from the examination and/or treatment room after the beginning of the on-site attendance period and communicating the results of the test to the central maintenance facility.

13. The method of claim 5 wherein, during the startup phase of the medical device, a vicinity check is automatically performed of at least one further device in the examination and/or treatment room.
